(19) United States
(12) Patent Application Publication
(10) Pub. No.: US 2026/0115924 A1
(43) Pub. Date: Apr. 30, 2026

(54) ROBOT OPERATION USING FEATURE MAP, STRUCTURE MESH, TEXTURE DATA, AND SEMANTIC MODEL

(71) Applicant: Lenovo Global Technology (United States) Inc., Morrisville, NC (US)

(72) Inventors: Song Wang, Morrisville, NC (US); Kevin W Beck, Morrisville, NC (US); Mengnan Wang, Morrisville, NC (US); Robert James Norton, JR., Morrisville, NC (US)

(21) Appl. No.: 18/932,603

(22) Filed: Oct. 30, 2024

(51) Int. Cl. B25J 9/16; G06T 17/20

(52) U.S. Cl. CPC B25J 9/1689; G06T 17/20; G06T 2200/24

(57) ABSTRACT

In one aspect, a device may include a processor system and storage accessible to the processor system. The storage may include instructions executable by the processor system to present a user interface (UI) that includes one or more options for an end-user to define restrictions related to robot operation in proximity to humans. The instructions may also be executable to receive user input to the UI that defines the restrictions related to robot operation in proximity to humans. The instructions may then be executable to operate the robot in conformance with the restrictions. In one particular instance, the instructions may be executable to access a feature map, a structure mesh, texture data, and a semantic model to accurately monitor the robot’s environment in real-time, allowing the robot to operate in conformance with the user-defined restrictions and re-route on the fly to avoid violating those restrictions.

### FIELD

The disclosure below relates to technically inventive, non-routine solutions that are necessarily rooted in computer technology and that produce concrete technical improvements. In particular, the disclosure below relates to robot operation using feature maps, structure meshes, texture data, and/or semantic models.

### BACKGROUND

As recognized herein, automated robots can be programmed to perform a variety of different tasks. However, often times performance of those tasks interferes with people in the same environment. The present disclosure further recognizes that robots typically have no way of knowing the adverse effects their actions have on the people around them, or even what to do when they encounter a person in their environment. With the foregoing in mind, the disclosure below recognizes that no adequate solutions currently exist to the foregoing computer-related, technological problems.

### SUMMARY

Accordingly, in one aspect a device includes a processor system and storage accessible to the processor system. The storage includes instructions executable by the processor system to present a user interface (UI). The UI includes one or more options for an end-user to define restrictions related to robot operation in proximity to a human. The instructions are also executable to receive user input to the UI, with the user input defining a first restriction related to robot operation in proximity to a human. The instructions are also executable, to identify attributes of a region in which the human is present and in which robot operation is restricted by the first restriction, to access each of a feature map of a geographic area, a structure mesh of the geographic area, texture data for the geographic area, and a semantic model of the geographic area The instructions are then executable to operate a robot to perform a designated task that involves geospatial movement of the robot in conformance with the first restriction using each of the feature map, the structure mesh, the texture data, and the semantic model.

In some example implementations, operation of the robot in conformance with the first restriction to perform the designated task that involves geospatial movement of the robot in conformance with the first restriction may include monitoring a physical location of the human relative to the robot.

Still further, in some cases the human may be present in a first physical area of the region, and operating the robot in conformance with the first restriction may include rerouting the robot to perform the designated task in a second physical area of the region in which the human is not present and that is not subject to the first restriction.

If desired, the end-user may be the human that the robot is restricted by the first restriction from operation in proximity thereto.

Still further, in some cases the instructions may be executable to, during operation of the robot, present a warning notification at a client device of the end-user. The warning notification may indicate robot operation or robot malfunction. So, for example, the instructions may be executable to present a warning notification indicating robot malfunction responsive to identification of a malfunction of the robot itself.

Additionally, in some examples the instructions may be executable to, during operation of the robot in conformance with the first restriction, present a prompt at a client device of the end-user. The prompt may request override of the first restriction.

In various examples, the first restriction may restrict the robot from coming within a threshold distance of a human when the human is identified as being below a predetermined age threshold. Additionally or alternatively, the first restriction may restrict the robot from coming within a threshold distance to the human during an event noted on an electronic calendar associated with the human.

In another aspect, a method includes presenting a user interface (UI) that includes one or more options for an end-user to define restrictions related to device operation in a particular area. The method also includes receiving user input to the UI, with the user input defining a first restriction related to device operation in the particular area. The method also includes accessing, to identify one or more attributes of a region in which a human is present and in which device operation is restricted by the first restriction, one or more of a feature map of the particular area, a structure mesh of the particular area, texture data for the particular area, and/or a semantic model of the particular area. The method then includes operating a device in conformance with the first restriction to perform a designated task that involves geospatial movement of the device.

In some instances, the device may be a robot, and here operating the device may include using the texture data and the semantic model to identify an object which the robot is to avoid. The method may also include using the feature map to reroute the robot from a first path to a second path to avoid the object. If desired, the method may further include, responsive to the robot malfunctioning, using the structure mesh to virtually attach a warning notification to the robot in three-dimensional (3D) space for the end-user to view the warning notification via an extended reality (XR) device.

In various examples, the first restriction may restrict the device from moving into an area, during a predetermined time of day, at which the robot is visible to a human. The predetermined time of day may be indicated via the UI.

As another example, the first restriction may restrict the device from coming within a threshold distance of objects classified as robots, where the robots may be different from the device itself.

In still another aspect, at least one computer readable storage medium (CRSM) that is not a transitory signal includes instructions. The instructions are executable by a processor system to identify a first restriction related to robot movement within a particular area. The instructions may also be executable to access, to identify one or more attributes of a region in which a human is present and in which robot operation is restricted by the first restriction, one or more of a feature map of the particular area, a structure mesh of the particular area, texture data for the particular area, and/or a semantic model of the particular area. The instructions are further executable to, based on the first restriction, adjust movement of the robot to perform a designated task that involves geospatial movement of the robot.

In some example implementations, the instructions may be executable to present a user interface (UI) that includes one or more options for an end-user to define the first restriction. The instructions may then be executable to identify the first restriction based on user input to the UI.

Also in some example implementations, the instructions may be executable to use first data to identify an object which, according to the first restriction, the robot is to avoid. The first data may include the texture data and/or the semantic model. According to these implementations, the instructions may then be executable to use the feature map to reroute the robot from a first path to a second path to avoid the object while the robot moves within the particular area.

Also in some example implementations, the instructions may be executable to use the structure mesh to virtually attach, in three-dimensional (3D) space, a virtual object to the robot for the end-user to view the virtual object via an extended reality (XR) device. In some examples, the virtual object may include a notification indicating the presence of the robot. Also in some examples, the virtual object may include replacement content to conceal the presence of the robot.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an illustration of a user working on a laptop computer while a robot performs a designated task in conformance with a restriction that the robot remain a threshold distance away from the user consistent with present principles;

FIG. 4 shows an example graphical user interface (GUI) through which an end-user may set one or more restrictions for the robot consistent with present principles;

FIG. 5 shows an example warning notification that may be presented to a user consistent with present principles;

FIG. 6 shows an example GUI that allows a user to override the robot’s restriction(s) so that the robot can complete a designated task consistent with present principles;

FIG. 7 shows an example implementation where virtual replacement content is presented in XR to visually conceal the presence of the robot consistent with present principles;

FIG. 8 shows another example warning notification that may be presented to a user consistent with present principles; and

FIG. 9 illustrates example logic that may be executed by a device consistent with present principles.

### DETAILED DESCRIPTION

Among other things, the detailed description below discusses devices and methods for creating technically-enhanced space management and robot functionality for residential, commercial and industrial spaces where both humans and robots coexist. Devices and methods are therefore described that advantageously use context-aware and location-aware applications to enable minimum disruption to human comfort while still allowing the robot to accomplish its scheduled tasks. In addition, present principles may improve the robot’s understanding of how spaces are utilized by both humans and robots.

To accomplish this, various types of map data/environmental digital data may be used to identify attributes of a region in which a human is present and in which robot operation is to be restricted. That data may include a feature map that provides spatial localization functions and location information for mobile devices such as smartphones, augmented reality (AR) glasses, and even the robots themselves. As one specific example, the feature map may be used for robot navigation.

A structure mesh may also be used by developers to support virtual-real fusion editing and path planning, with overlaid AR contents possibly being presented on top of physical objects.

Texture data may also be used, which may provide high-fidelity robot visualization of a three-dimensional (3D) scene to help create an interactive user experience. The texture data may include object surface/appearance qualities such as color, lighting, exhibited pattern, physical texture, etc.

A semantic model may also be used to provide detection and recognition capabilities for objects inside the 3D scene, such as object recognition from big data and/or user labelling so that the semantic model indicates object IDs for various objects in the model (and therefore in the 3D real space itself).

Accordingly, a combination of those four types of map data (feature map, structure mesh, texture data, and semantic model) may be combined with metadata related to the robot as well as contextual information relevant to all users inside the real-world space to, in turn, achieve optimal understanding for better space management in real time through a purpose-designed user experience (UX)/user interface (UI).

For example, in residential, industrial, and commercial spaces, robots might be assigned to perform routine/prescheduled tasks. Depending on time of the day, the robots might encounter humans, which could cause a human response that might include discomfort, inconvenience, and even danger to the humans themselves. Present principles therefore describe devices and methods that allow each user to set their own preferences/criteria through a designated UI/UX, thereby allowing real time route and distance management between the users and robots.

The locations of all users and robots inside the space may be tracked in real time and managed via a system/software service. Thus, if there is conflict or notification required based on a given restriction, the conflict or notification can be sent to the appropriate users and/or the robot at a specified location. The users can even select particular settings such as but not limited to: (1) No robot or robot visibility within “n” meters of the user; (2) No robot or robot visibility/activity during a meeting time or certain time of the day; (3) Setting for the robot to avoid members of a family such as small children, or even a setting for the robot to avoid animals and/or other robots; (4) Setting for the robot to avoid selected inanimate objects and specified regions/geolocations.

In turn, robots that perform tasks that may pose certain physical risks can also be preset with criteria to alert nearby humans to avoid encounter. This allows the robot to continue a scheduled task without route replanning. Especially during an emergency where the robot malfunctions or otherwise experiences unexpected behavior, the real time notification can be sent to all nearby users whose locations are tracked, and their mobile devices may then provide appropriate notifications. For users with AR glasses, a superposition of virtual contents can even be displayed for both notification purposes and to replace robot presence with other virtual content if desired. In addition, users with admin permissions can replan robot activities/path based on real time feedback.

What’s more, robot type consistent with present principles may not be limited to mobile robots. For example, present principles may also apply to stationary robots and even machinery such as a forklift. So, for example, a traditional non-smart forklift can achieve device intelligence by equipping the forklift with external cameras/sensors that detect human presence and distance of incoming workers/obstacles. Upon detection, notification and virtual contents can be sent to human operators and passerby workers. The operator with AR glasses can be notified if objects and humans come within a dangerous distance of the forklift and then stop operation of the forklift/robot. Similarly, passersby can be notified of the presence of machinery in operation and be routed in real time themselves to take a different path (through AR/mobile glass cardinal directions).

Still further, the fusion map above (combined data of feature map, structure mesh, texture data, and semantic map) can be used with real time tracking of humans and robots to build a space usage analysis overtime, especially for areas of high interest. This allows the facility to use this information to better manage furniture, utilities, and robot task planning through the resulting activity heat map. The system can therefore detect patterns such as how often a user uses a particular area for its intended purpose, and whether another location is better-suited as the new designated area for the robot or human due to more frequent traffic at the first area.

Thus, the heat map can allow the administrator of the space to gain a large amount of knowledge on how the space is being utilized, knowing where humans and robots interact the most, when and where humans reject robot presence the most, and how the furniture and other objects in the space are being utilized. This in turn may allow the admin to use that information to rearrange the factory to be more efficient through a back-end technical analysis. For example, a pattern recognition model can be used, as well as the number of requests humans make for robot restrictions in certain locations, so that the system knows what areas have the most notifications and commands being sent. The system can thus infer where robot/human interactions occur the most and request for robots to go away from those areas. Rules-based algorithms and statistical models may also be used.

Robots/devices subject to restrictions consistent with present principles may include, but are not limited to, humanoid robots, autonomous vacuums, autonomous vehicles, autonomous forklifts, drones, functional robots in factories and workplaces, robotic arms, wheeled robots, 4-legged robots, 6-legged robots, 8-legged robots, etc. More generally, in non-limiting implementations, robots may be established by automated machines that can move across and within real space to execute specific tasks.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

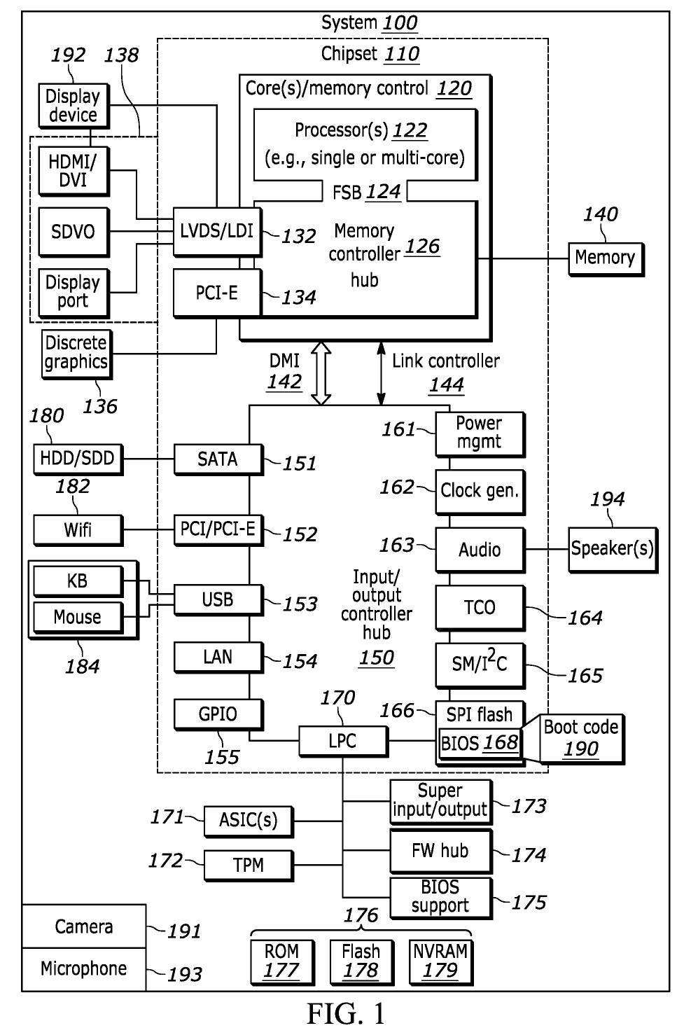

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include a camera 191 that gathers one or more images and provides the images and related input (e.g., metadata like an image timestamp) to the processor system 122. The camera 191 may be a thermal imaging camera, an infrared (IR) camera, a digital camera such as a webcam, a three-dimensional (3D) camera, and/or a camera otherwise integrated into the system 100 and controllable by the processor system 122 to gather still images and/or video (e.g., for computer vision to monitor robot activity and/or human presence consistent with present principles). The system 100 may also include an audio receiver/microphone 193 that provides input from the microphone to the processor system 122 based on audio that is detected, such as via a user providing audible input to the microphone (e.g., for speech recognition to monitor robot activity and/or human presence consistent with present principles).

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122. Those sensors may be used for robot navigation via dead reckoning, if desired.

Also, the system 100 may include a global positioning system (GPS) transceiver that is configured to communicate with satellites to receive/identify geographic position information and provide the geographic position information to the processor system 122. The GPS transceiver may therefore also be used for robot navigation consistent with present principles. However, it is to be understood that another suitable position receiver other than a GPS receiver may be used in accordance with present principles to determine the location of the system 100 and/or navigate a robot.

It is to be understood that an example client device or other machine/computer may include fewer or more features than shown on the system 100 of FIG. 1. In any case, it is to be understood at least based on the foregoing that the system 100 is configured to undertake present principles.

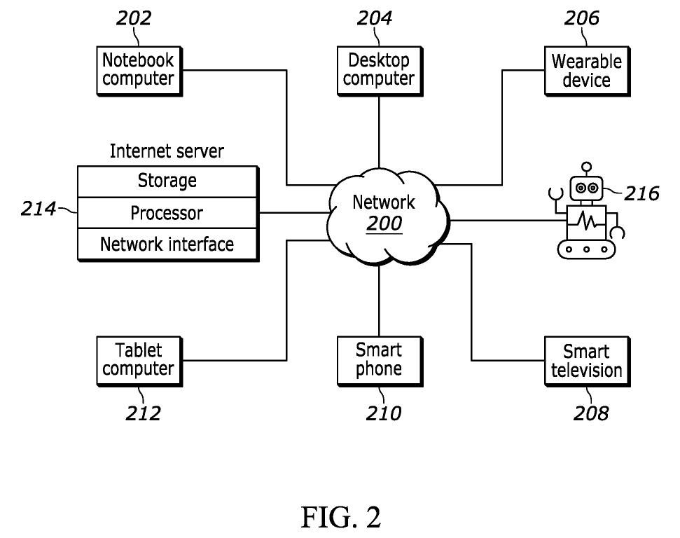

Turning now to FIG. 2, example devices are shown communicating over a network 200 such as the Internet to undertake present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook/laptop computer 202, a desktop computer 204, a wearable device 206 such as smart glasses, a smart television (TV) 208, a smart phone 210, a tablet computer 212, a humanoid robot 216, and a server 214 such as an Internet server that may provide cloud storage accessible to the devices 202-212, 216. It is to be understood that the devices 202-216 may be configured to communicate with each other over the network 200 to undertake present principles. For example, the robot 216 may communicate with the server 214 and with client devices like the smartphone 210 to undertake present principles.

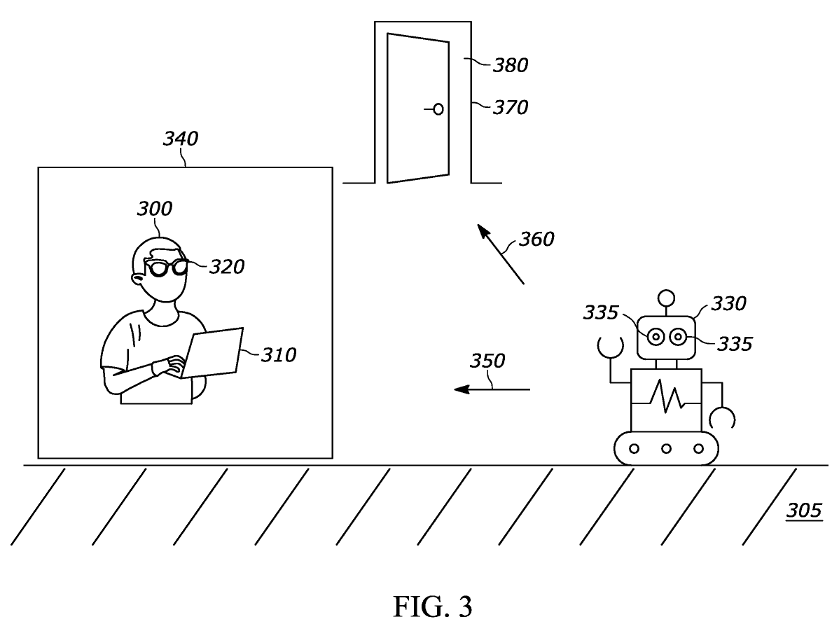

Now in reference to FIG. 3, suppose an end-user 300 is working on a laptop computer 310 during normal business hours while also wearing smart glasses 320. The laptop 310 and glasses 320 may each include some or all of the components of the system 100.

Also suppose a humanoid robot 330 is traversing the same area 305 to perform one or more designated tasks that involve geospatial movement of the robot 330, such as vacuuming debris off the ground or moving objects from one location to another within the area 305. The robot 330 may also include some or all of the components of the system 100. As such, the robot 330 may have cameras 335 for eyes, allowing the robot 330 and/or a connected server to execute computer vision for object recognition via a semantic map and texture data (using real-time video from the cameras 335 as the robot 330 moves about the environment). Additionally, to aid its navigation about the area 305 to perform its tasks, the robot 330 may use a preregistered feature map of the area 305 to track its position and geospatial navigation within the area 305 via the cameras 335. Thus, as the robot 330 moves throughout the area 305 with the aid of the feature map to perform its tasks, the robot 330 might use the texture data for the area 305 and the semantic model of the area 305 to identify the user 300.

Also suppose per this example that the user 300 has configured a restriction for the robot 330 that requires the robot 330 to stay outside of a threshold distance of the user 300 during the normal business hours of 8:00 am to 5:00 pm on weekdays. The threshold distance is represented by box 340 in FIG. 3, and may establish a threshold number of feet or meters away from the user in all directions. Accordingly, as the robot 330 moves toward and recognizes the user 300 while traversing along a first route represented by arrow 350, the robot 330 may use its cameras 335, a light detection and ranging (lidar) system, GPS transceiver, and/or other navigational sensors to determine it is approaching the user 300 to within the threshold distance 340. Responsive to identifying as much, the robot 330 may then reroute itself to change direction and instead traverse another route represented by arrow 360. This allows the robot 330 to continue executing its designated tasks by going through a doorway 370 and into another room 380 whilst leaving the user 300 alone in the area 305 during the period of restriction (normal business hours per this example).

The robot 330 may also make a note in its electronic task log to revisit the area 305 to complete the task(s) it was attempting to complete along the route 350 before the user’s restriction impacted the robot’s operation to redirect the robot into the room 380. For example, based on a note in its electronic task log, the robot 330 may return after normal business hours to the portion of the area 305 that the user 300 occupied to thus complete its designated task(s) in that area at a time that does not interfere with the user’s daily business activities.

Before moving on, also note consistent with present principles that the transparent display(s) of the user’s smart glasses 320 may present notifications and/or other virtual content related to the robot 330 as the robot moves about the area 305. For example, the glasses 320 may use a structure mesh to attach virtual content to the robot as the robot moves, such as a “robot” sign that virtually hovers in 3D over the robot’s head as the robot 330 moves about in 3D real space. Or the glasses 320 might control their display(s) to present virtual content that conceals the presence of the robot 330 while the robot 330 is in the area 305 so that the user 300 cannot see the robot 330 through the glasses 320 and hence may not be as distracted by the robot 330 while working. These example implementations will be discussed in greater detail below. But note here that the glasses 320 may use stereoscopic images and augmented reality (AR) software, as well as the fusion map data set forth above, to present the virtual content to appear in space as if the virtual content were located in real world 3D space.

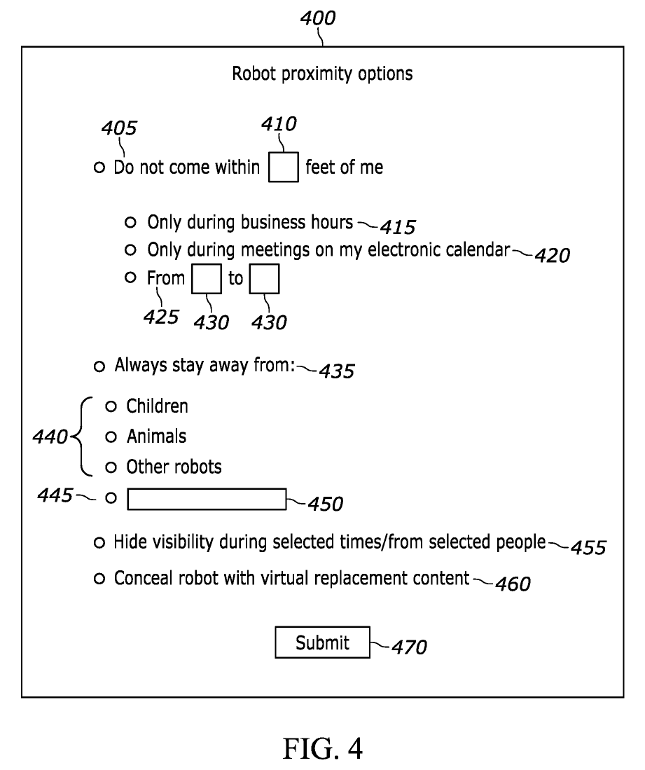

Now in reference to FIG. 4, this figure shows a user interface (UI) that may be used to configure one or more robot restrictions consistent with present principles. In the present example, the UI is a graphical user interface (GUI) 400. However, further note that other types of UIs may be used, such as an audio UI where the text of the GUI 400 is read aloud using text-to-speech software, and then a microphone along with speech recognition software is used to detect audible user responses to the audible UI. A combination of UI types might also be used, such as where the GUI 400 is presented but the user provides audible selections via a microphone.

In any case, in terms of the GUI 400 of FIG. 4, note that it may present various options through the selectable radio buttons and text entry boxes shown. Other types of user input elements may also be included as options.

As shown in FIG. 4, the GUI 400 may include a first option 405 that is selectable to restrict the robot to which the GUI 400 pertains from moving to within a threshold distance of all humans and/or the particular user themselves. The threshold distance may be settable by the end-user by directing numerical input to the number entry box 410 using a hard or soft keyboard.

Additionally, the user might desire the restriction associated with the option 405 to only apply in certain circumstances rather than at all times of day on all days. To set the restriction accordingly, the user might select one or more of the options 415, 420, 425. The option 415 may be selectable to set a restriction for the robot to not come within the threshold distance to the user during normal business hours like in the example of FIG. 3 above. The option 420 may be selectable to set a restriction for the robot to not come within the threshold distance to the user during times during which the user is in a meeting as identified from a corresponding meeting entry in the user’s electronic calendar (to which the robot and/or a coordinating server has been granted access). The option 425 may be selectable to set a restriction for the robot to not come within the threshold distance to the user during a certain time range spanning from a first time of day to a second time of day as defined by the user through entry of the respective times of day into the respective number entry boxes 430 shown in FIG. 4. Again note that more than one of the options 415-425 may be selected at the same time to thus set plural robot restrictions that remain concurrently in effect.

Therefore, the option 415 may be selected to restrict the robot from coming, during business hours, within a threshold distance to a designated person(s) (at least the user themselves in this instance). The option 420 may be selected to restrict the robot from coming, during an event noted on the designated person’s electronic calendar, within the threshold distance to the designated person. The option 425 may be selected to restrict the robot from coming, during a particular time frame indicated by the designated person, within the threshold distance to the designated person.

As also shown in FIG. 4, the GUI 400 may include additional options such as an option 435 that is selectable to set a restriction for the robot to always stay a threshold distance away from certain predetermined humans, animals, and inanimate objects (e.g., regardless of time of day, day of the week, etc.). As such, the GUI 400 may include sub-options 440 that are respectively selectable to set corresponding restrictions that restrict the robot from coming within humans classified as children/within a threshold distance of a human when the human are identified as being below a predetermined age threshold, objects classified as animals, and even objects classified as other robots (to avoid robot collisions while each robot is attempting to perform its designated task). Note that classification may occur using the aforementioned semantic model and texture data as well as real-time images from the robot’s camera(s) as processed via computer vision.

What’s more, in some instances the GUI 400 may include an option 445 with an alphanumeric text entry box 450. The option 445 may therefore be selected to restrict the robot from coming within the threshold distance to an object specified by the user in box 450 using freeform text, with semantic understanding of the user’s text then being gained through natural language processing for the robot to subsequently identify objects within its environment that correspond to the object entered by the user into the box 450 (thus notifying the robot to avoid those objects). The object might be an inanimate object that the user does not want to collide with the robot, a particular person other than the user, a particular type of animal, or even a particular animal such as the user’s own dog.

FIG. 4 also shows that the GUI 400 may include an option 455 that is selectable to restrict the robot from moving into a given area at which the robot is visible to the user (and/or any or all humans in the same vicinity). If the user has already set predetermined times of day during which the robot is to avoid coming within the threshold distance to the user as set forth above, those times of day may control for the restriction associated with the option 455 in that selection of the option 455 may restrict the robot from also coming within viewing range of the designated people during those predetermined time(s) of day (e.g., even if the robot remains physically outside of the threshold distance itself).

Similarly, if the user has already designated certain people that the robot is to avoid coming within the threshold distance of as also set forth above, those people may control for the restriction associated with the option 455 in that selection of the option 455 may restrict the robot from coming within viewing range of the designated people at all times of day. Thus, the robot may avoid traversing, at all times of day, into a particular area at which it can be viewed by the designated people while moving about to perform its designated task.

The GUI 400 may also include an option 460 that is selectable to set or configure the user’s own client device to use a structure mesh to conceal the robot from the user’s view using virtual replacement content presented on the display of the user’s smart glasses (more generally, a headset) while the user wears the glasses. In this way, a robot that might otherwise be viewable to the user with the naked eye is concealed from the user’s view by controlling the glasses to overlay virtual replacement content on the glasses’ display to obstruct the user’s line of sight to the robot itself, helping to prevent the user from being distracted by the robot while the robot performs its automated tasks. This aspect will be discussed in greater detail below in reference to FIG. 7.

But still in reference to FIG. 4, note that the GUI 400 may also include a submit selector 470. The selector 470 may be selected to configure the robot in accordance with the restrictions set via the rest of the GUI 400. Also note that other restrictions may also be set via a UI consistent with present principles and that the ones discussed above are but examples.

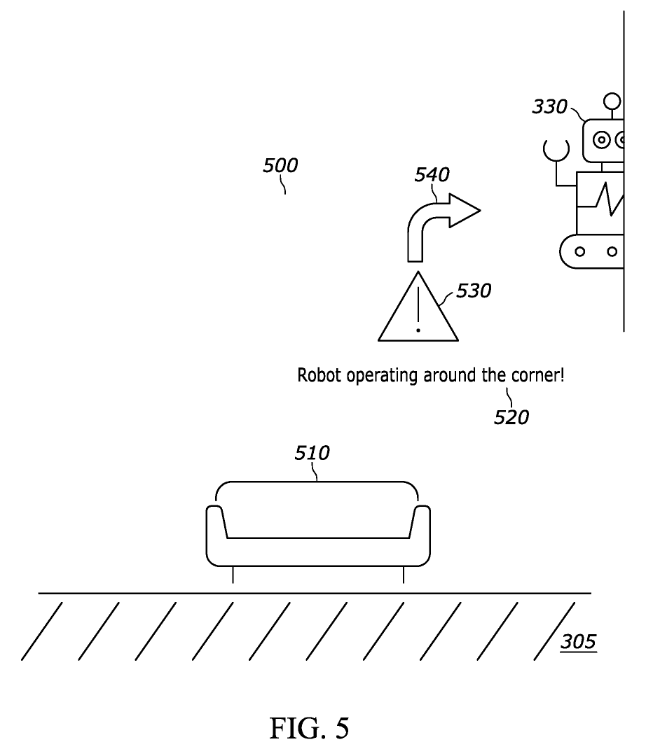

Now in reference to FIG. 5, suppose the user is still in the area 305 but decides to get up and walk around. As the robot cannot predict what change in direction the user might make at any given time while walking (and hence might not be able to adequately maintain the threshold distance away from the user), FIG. 5 demonstrates that, during robot operation, the user’s smart glasses or other client device display may use a structure mesh to anchor a warning notification to the robot 330 in 3D space. The warning notification may indicate robot operation or even robot malfunction. In the present instance, assume normal robot operation without malfunction and so here the notification might include the word “robot” hovering over the robot’s head as the robot 330 moves through space.

Additionally, to help avoid a collision between the human and robot, or at least to otherwise help the user maintain the threshold distance away from the robot, the user’s smart glasses may present/overlay virtual content 500 on the user’s field of view as represented in FIG. 5. Thus, it is to be understood that the field of view shown in FIG. 5 is that of the user while looking out at the user’s environment through the transparent display of the user’s smart glasses.

With this understanding, note that a real-world tangible couch 510 is shown within the area 305, as well as the real-world tangible robot 330 itself. Also note that the robot 330 is coming around a corner within the area 305 and hence is only partially visible to the user, increasing the potential danger to the user as the user cannot fully see the robot 330 as the user walks around. But owing to the robot’s use of a feature map of the area 305 as well as other navigational technologies (e.g., GPS transceivers on the robot and user’s smart glasses) to monitor the physical location of the user relative to the robot 330, the relative positions of the user and robot 330 can be tracked in real time to monitor the user as the user approaches the robot 330.

As such, the aforementioned virtual content 500 and/or other notifications may be presented in response to indicate the presence of the robot 330. Note that the content 500 in this example includes text 520 indicating that the robot 330 is around the corner, as well as a caution icon 530 and indicator arrow 540 that indicates the direction of the robot 330 relative to the viewing angle of the user.

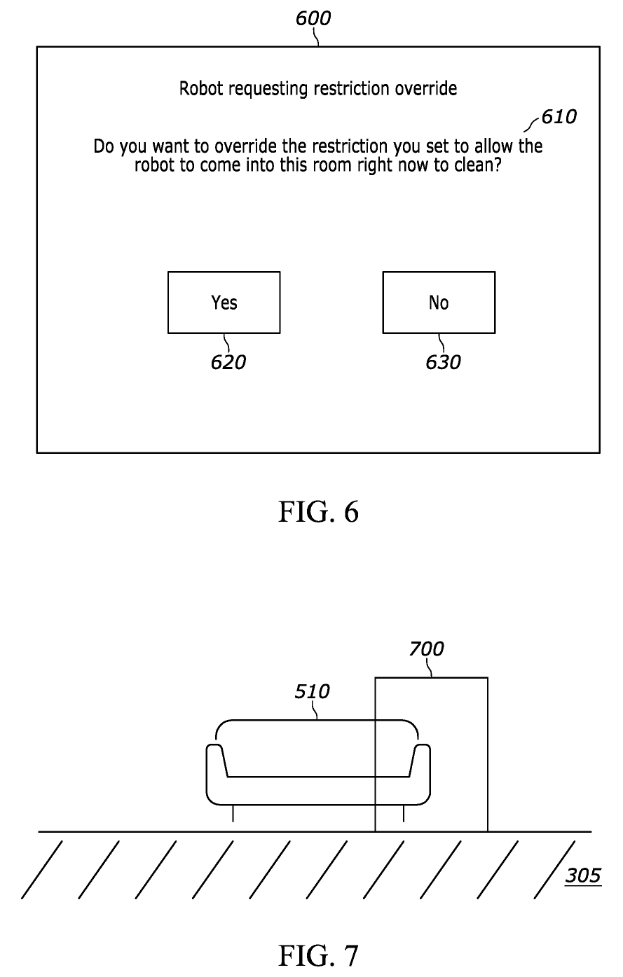

Now suppose the robot 330 needs to perform a certain task in the area 305 to stay on schedule and/or complete a designated task and, as such, cannot reroute for some reason (e.g., the robot has already completed its designated tasks in all other areas). FIG. 6 demonstrates through the GUI 600 that, in such an instance, the robot 330 may request override of its restriction that would otherwise prevent the robot 330 from completing its designated task in the area 305.

Accordingly, FIG. 6 shows that during operation of the robot 305 in conformance with its restriction(s), a prompt 610 may be presented as part of the GUI 600 at the user’s client device (e.g., smart glasses or even smartphone). As shown, the prompt requests override of the relevant restriction(s), indicating “Do you want to override the restriction you set to allow the robot to come into this room right now to clean?” The user may then either select the “yes” selector 620 to override the restriction, or select the “no” selector 630 to deny override and allow the restriction to remain in effect.

Turning to FIG. 7, suppose a situation where the user has set a restriction for the robot 330 to remain out of the user’s view at all times or at least in certain circumstances designated by the user via the GUI 400. FIG. 7 therefore demonstrates that the user’s smart glasses or other extended reality (XR) device may present virtual/XR content in the user’s field of view in the user’s viewing direction toward the robot 330, with the virtual content acting as replacement content to conceal the presence of the robot 330. The virtual content may be created using the area’s preregistered texture data for the virtual content to match/appear with the same texture (visual appearance) as nearby real-world objects behind the robot (behind relative to the user’s position). A structure mesh may then be used to anchor the virtual content to the associated real-world object locations themselves, with XR software then being used to change the appearance of the virtual content over time to match the user’s viewing angle toward the associated real-world object as the user’s viewing angle changes.

Thus, note in the present example that virtual content 700 is shown in the form of a virtual graphic of part of the couch 510. It is to be understood that the content 700 therefore shows portions of the couch 510 that would otherwise be obstructed from the user’s view by the robot 330 as the robot 330 moves laterally between the couch 510 and user. The content 700 may also be updated in real time as the robot 330 continues to move between the user and couch 510, representing additional portions of the couch 510 that subsequently become blocked from view by the robot 330. Accordingly, it may be appreciated from this example that the virtual content 700 conceals the presence of the robot 330 through its presentation via XR software, matching the real-world appearance (and position) of portions of the couch that are blocked by the robot 330 at any given time. Therefore, the combination of the user’s real-world view and XR content present a seamless view of the couch 510 without the robot 330 being shown, as if the robot 330 was never there and the user had a clear line of sight to the couch 510.

Before moving on, note in terms of the aforementioned XR device and XR content that XR includes, but is not limited to, augmented reality (AR), virtual reality (VR), and mixed reality (MR)-type devices and content.

Also before moving on, note that still other content may be presented to conceal the presence of the robot 330, but the other content need not necessarily match and seamlessly blend into the real-world environment like the content 700. Instead, a blob, virtual character, or other virtual object that is unassociated with the user’s real-world view of the environment may be presented instead of the content 700 to block the user’s line of sight to the robot 330.

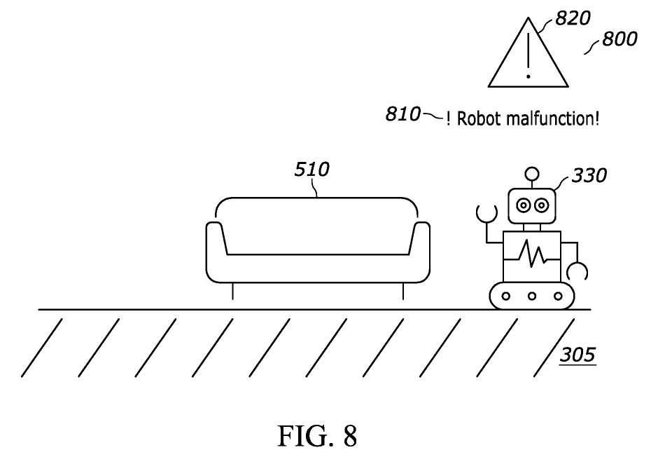

Now in reference to FIG. 8, suppose the robot 330 malfunctions for some reason while performing its designated task(s). This may create a safety hazard to the user as the robot does not move as intended or might move in unexpected manners. FIG. 8 therefore demonstrates that during operation of the robot 330, the user’s smart glasses or other client device display may present a warning notification 800 indicating robot malfunction, which may be presented responsive to identification of a malfunction of the robot 330 (e.g., as identified by the robot 330 itself or a coordinating device such as a server or the user’s smart glasses).

As shown in FIG. 8, the notification 800 includes text 810 indicating, “!Robot Malfunction!” The notification 800 also includes a caution icon 820. The user may thus become immediately aware of the robot’s malfunction to stay away from the robot to prevent injury, or even to take remedial action to fix the malfunctioning robot itself.

Again note that a structure mesh may be used to virtually anchor the 3D position of the notification 800 to the 3D area above the robot’s head so that the notification 800 remains viewable adjacent to (above) the robot no matter the user’s line of sight or movement of the robot 330. But also owing to its anchoring in 3D space to the location of the robot 330 itself, the notification 800 may not be presented in the user’s line of sight through the glasses when the user looks elsewhere away from the direction of the robot 330 to thus leave the user’s view of other parts of the real world unobstructed for safety reasons.

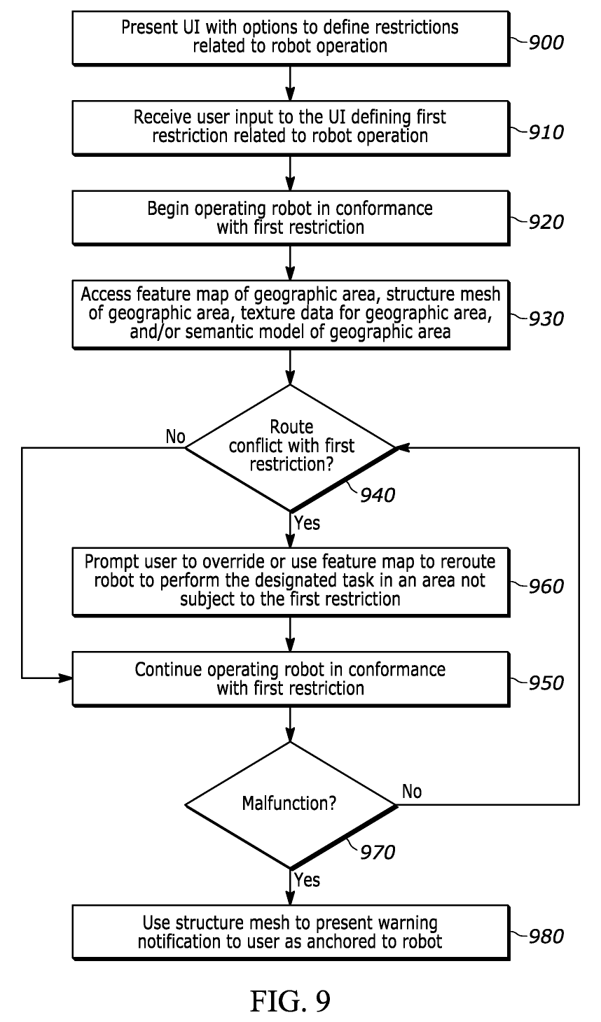

Continuing the detailed description in reference to FIG. 9, this figure shows example logic that may be executed by a device such as the system 100, robot 330, and/or a coordinating server alone or in any appropriate combination consistent with present principles. Thus, in some examples the logic may be executed by a client device/robot alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 9 is shown in flow chart format, other suitable logic may also be used.

Beginning at block 900, the device may present a UI with options for an end-user to define restrictions related to robot operation and movement in a particular area, robot operation in proximity to a human, etc. For example, at block 900 the device may present an audible UI and/or the GUI 400 of FIG. 4.

From block 900 the logic may then proceed to block 910. At block 910 the device may receive user input to the UI that defines at least a first restriction related to robot operation (and identify the first restriction based on user input to the UI). The logic may then proceed to block 920 where the device begins operating the robot in conformance with the selected restriction(s).

From block 920 the logic may proceed to block 930. At block 930 the device may access one or more of a feature map of the relevant geographic area, a structure mesh of the relevant geographic area, texture data for the relevant geographic area, and/or a semantic model of the relevant geographic area to ultimately operate the robot in conformance with the restriction(s) using some or all of the feature map, the structure mesh, the texture data, and the semantic model.

Accordingly, the logic may proceed to decision diamond 940 where the device may determine whether there is a route conflict according to one or more of the restrictions set by the user such that the robot following a primary, default, or pre-planned route would lead to violating one of the restrictions. For instance, the device may use the semantic model and texture data accessed at block 930 to identify real-world objects to which a restriction applies (e.g., using computer vision). A negative determination may cause the logic to proceed directly to block 950 where robot operation may continue along the same route still in conformance with the restriction(s).

However, an affirmative determination at diamond 940 may instead cause the logic to proceed to block 960. At block 960 the device may do one or both of two things. The first thing is to prompt the user to override the relevant restriction. The second thing is to use the feature map to control the robot to reroute the robot to a different path to perform its designated task in an area that is not subject to the restriction (or take another action for the robot to otherwise avoid violating the relevant restriction). From block 960 the logic may then proceed to block 950 where robot operation may continue in conformance with the first restriction (along the different path/route).

From block 950 the logic may then proceed to decision diamond 970. At diamond 970 the device may determine whether a robot malfunction has occurred. The malfunction may be determined from sensors on the robot or in the environment, such as a camera mounted on a wall so that computer vision may be executed to determine that the robot has stopped moving. As another example, the processor on the robot may report the malfunction based on an identified software glitch, operating system crash, or something else identifiable by the processor.

A negative determination at diamond 970 may cause the logic to revert back to diamond 940 to proceed again therefrom. However, an affirmative determination at diamond 970 may instead cause the logic to proceed to block 980. At block 980, responsive to the robot malfunctioning, the device may use a structure mesh to virtually attach, in 3D space, a warning notification to the robot for the end-user to view the warning notification via an extended reality (XR) device. Thus, at block 980 the device may present a warning notification to the user to indicate robot malfunction, with the notification being presented in the user’s line of sight toward the robot as anchored to the robot per the description above.

Momentarily referring back to steps 920 and 950, it is to be understood consistent with present principles that in various example implementations, operating the robot in conformance with the user’s restriction(s) does not include any of turning the robot off, leaving the robot off, leaving the robot in a stationary position, and leaving the robot on but not permitting the robot to perform a designated task that involves geospatial movement of the robot. Instead, operating the robot in conformance with the first restriction might include rerouting the robot to perform the designated task in an area not subject to the user’s restrictions or otherwise adjusting movement of the robot to not violate the restrictions while the robot continues to operate/perform a designated task.

Therefore, in one particular example, operating the robot may include using the texture data and/or semantic model accessed at block 930 to identify an object which the robot is to avoid according to the user’s restriction(s), and then using the feature map also accessed at block 930 to reroute the robot from a first path to a second path to avoid the object while continuing to perform the robot’s designated task. Also if desired, the device executing the logic of FIG. 9 may use the structure mesh accessed at block 930 to virtually attach, in 3D space, a virtual object to the robot as the robot continues to move about in the second path for the end-user to view the virtual object via an XR device as though the virtual object is moving through 3D space with the robot.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. An apparatus, comprising:
a processor system; and
storage accessible to the processor system and comprising instructions executable by the processor system to:
present a user interface (UI), the UI comprising one or more options for an end-user to define restrictions related to robot operation in proximity to a human;
receive user input to the UI, the user input defining a first restriction related to robot operation in proximity to the human;
access each of: a feature map of a geographic area, a structure mesh of the geographic area, texture data for the geographic area, and a semantic model of the geographic area to identify attributes of a region in which the human is present and in which robot operation is restricted by the first restriction;
operate a robot to perform a designated task that involves geospatial movement of the robot in conformance with the first restriction in the region using each of the feature map, the structure mesh, the texture data, and the semantic model.

2. The apparatus of claim 1, wherein operation of the robot in conformance with the first restriction to perform the designated task that involves geospatial movement of the robot in conformance with the first restriction comprises monitoring a physical location of the human relative to the robot.

3. The apparatus of claim 1, wherein the human is present in a first physical area of the region, and wherein operating the robot in conformance with the first restriction comprises rerouting the robot to perform the designated task in a second physical area of the region in which the human is not present and that is not subject to the first restriction.

4. The apparatus of claim 1, wherein the end-user is the human that the robot is restricted by the first restriction from operation in proximity thereto.

5. The apparatus of claim 1, wherein the instructions are executable to:
during operation of the robot, present a warning notification at a client device of the end-user, the warning notification indicating robot operation or robot malfunction.

6. The apparatus of claim 5, wherein the warning notification indicates robot malfunction, and wherein the instructions are executable to:
present the warning notification responsive to identification of a malfunction of the robot.

7. The apparatus of claim 1, wherein the instructions are executable to:
during operation of the robot in conformance with the first restriction, present a prompt at a client device of the end-user, the prompt requesting override of the first restriction.

8. The apparatus of claim 1, wherein the first restriction restricts the robot from coming within a threshold distance of the human when the human is identified as being below a predetermined age threshold.

9. The apparatus of claim 1, wherein the first restriction restricts the robot from coming within a threshold distance to the human during an event noted on an electronic calendar associated with the human.

10. A method, comprising:
presenting a user interface (UI), the UI comprising one or more options for an end-user to define restrictions related to device operation in a particular area;
receiving user input to the UI, the user input defining a first restriction related to device operation in the particular area;
accessing, to identify one or more attributes of a region in which a human is present and in which device operation is restricted by the first restriction, one or more of: a feature map of the particular area, a structure mesh of the particular area, texture data for the particular area, and a semantic model of the particular area; and
operating the device in conformance with the first restriction to perform a designated task that involves geospatial movement of the device.

11. The method of claim 10, wherein the device is a robot, and wherein operating the device comprises:
using the texture data and the semantic model to identify an object which the robot is to avoid; and
using the feature map to reroute the robot from a first path to a second path to avoid the object.

12. The method of claim 11, comprising:
responsive to the robot malfunctioning, using the structure mesh to virtually attach, in three-dimensional (3D) space, a warning notification to the robot for the end-user to view the warning notification via an extended reality (XR) device.

13. The method of claim 10, wherein the first restriction restricts the device from moving into an area, during a predetermined time of day, at which the device is visible to a human, the predetermined time of day indicated via the UI.

14. The method of claim 10, wherein the first restriction restricts the device from coming within a threshold distance of objects classified as robots, the robots being different from the device.

15. At least one computer readable storage medium (CRSM) that is not a transitory signal, the at least one CRSM comprising instructions executable by a processor system to:
identify a first restriction related to robot movement within a particular area;
access, to identify one or more attributes of a region in which a human is present and in which robot operation is restricted by the first restriction, one or more of: a feature map of the particular area, a structure mesh of the particular area, texture data for the particular area, and a semantic model of the particular area; and
based on the first restriction, adjust movement of the robot to perform a designated task that involves geospatial movement of the robot.

16. The at least one CRSM of claim 15, wherein the instructions are executable to:
present a user interface (UI), the UI comprising one or more options for an end-user to define the first restriction; and
identify the first restriction based on user input to the UI.

17. The at least one CRSM of claim 15, wherein the instructions are executable to:
use first data to identify an object which, according to the first restriction, the robot is to avoid, the first data comprising one or more of: the texture data, the semantic model; and
use the feature map to reroute the robot from a first path to a second path to avoid the object while the robot moves within the particular area.

18. The at least one CRSM of claim 15, wherein the instructions are executable to:
use the structure mesh to virtually attach, in three-dimensional (3D) space, a virtual object to the robot for the end-user to view the virtual object via an extended reality (XR) device.

19. The at least one CRSM of claim 18, wherein the virtual object comprises a notification indicating the presence of the robot.

20. The at least one CRSM of claim 18, wherein the virtual object comprises replacement content to conceal the presence of the robot.
